(19) United States
(12) Patent Application Publication
(10) Pub. No.: US 2006/0291468 A1
(43) Pub. Date: Dec. 28, 2006

(54) Selective re-transmission of lost multi-media data packets

(76) Inventors: Rajendra Bopardikar, Phoenix, AZ (US); Dmitrii Loukianov, Chandler, AZ (US)

Correspondence Address: BUCKLEY, MASCHOFF, TALWALKAR LLC, 5 ELM STREET, NEW CANAAN, CT, 06840, US

(21) Appl. No.: 11/158,374

(22) Filed: Jun. 22, 2005

(51) Int. Cl. H04L 12/56

(52) U.S. Cl. 370/392; 370/394

(57) ABSTRACT

A method includes loading video data into packets and appending headers to the packets. Each of the headers includes a first field and a second field. The first field includes a data value to indicate an importance of a respective packet relative to other packets. The second field includes an importance level sequence number to indicate a position of the respective packet in a sequence of packets which have the same importance level as the respective packet.

### BACKGROUND

Home multi-media networks have been proposed. In some proposals, multi-media data such as video and/or audio may be transmitted via wireless links utilizing a protocol such as RTP (“Real Time Protocol”).

One possible drawback of the proposed networks is that the wireless links may not be very reliable, so that some data packets may be lost. As a result, rendering of the image and/or audio streams at the receiving device may be disrupted. It has been proposed to re-transmit lost packets, but bandwidth restrictions may inhibit lost packet re-transmissions.

### BRIEF DESCRIPTION OF THE DRAWINGS

FIG. 1 is a block diagram showing components of a wireless multi-media system provided according to some embodiments.

FIG. 2 is a block diagram which shows some details of a media server device that is part of the system of FIG. 1.

FIG. 3 is a block diagram which shows some details of a packet assembly block that is part of the media server device of FIG. 2.

FIG. 4 is a schematic illustration of a header format for packets transmitted by the media server device of FIG. 2.

FIG. 5 is a block diagram which shows some details of a client device that is part of the system of FIG. 1.

FIG. 6 is a block diagram which shows some details of a packet handling block that is part of the client device of FIG. 5.

FIG. 7 is a schematic illustration of a format for a re-transmission request message that is transmitted by the client device of FIG. 5.

FIG. 8 is a flow chart that illustrates a process performed by the server device of FIG. 2.

FIGS. 9A and 9B together form a flow chart that illustrates a process performed by the client device of FIG. 5.

### DETAILED DESCRIPTION

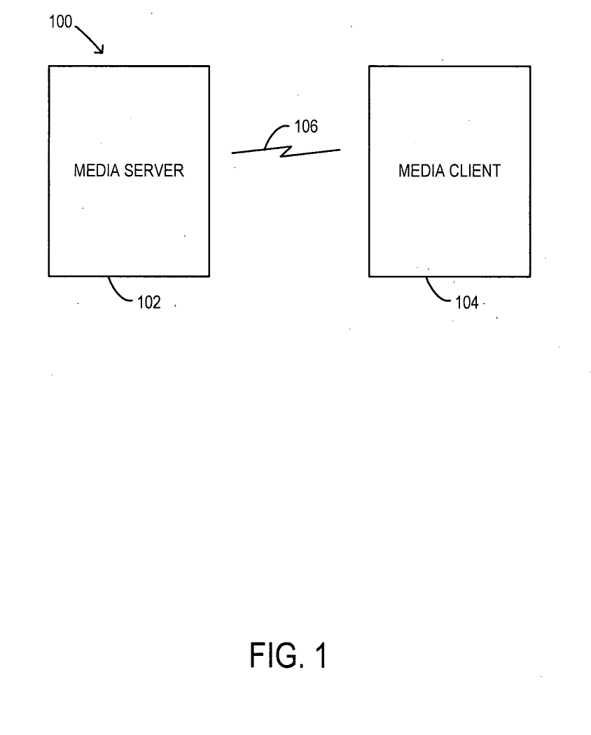

FIG. 1 is a block diagram showing components of a wireless multi-media system 100 provided according to some embodiments. The system 100 includes a media server device 102 which transmits one or more of video data, audio data and other data to a client device 104 which is also part of the system 100. The data transmission may be via a wireless data communication link, which is indicated at 106.

In some embodiments, the server device 102 may be, or may be connected to, a cable television box, a DVD player or a personal computer or home media network hub. In some embodiments, the client device 104 may be, or may be connected to, an intelligent TV, a personal computer, or a laptop computer.

The system 100 may also include one or more other client devices (not shown) to receive multi-media data from the server device 102. The physical aspects of the wireless data communication link 106 may be provided in accordance with a standard such as IEEE 802.11.

In some embodiments, the server device 102 and the client device 104 may both be constituted by standard hardware programmed to operate in accordance with embodiments described herein. For example, each of the server device 102 and the client device 104 may include one or more processors coupled to a memory device or devices which store software instructions to control the processor(s) to operate as described herein. In addition, or alternatively, at least some of the functions described herein may be performed by custom integrated circuit logic designed specifically to perform such functions.

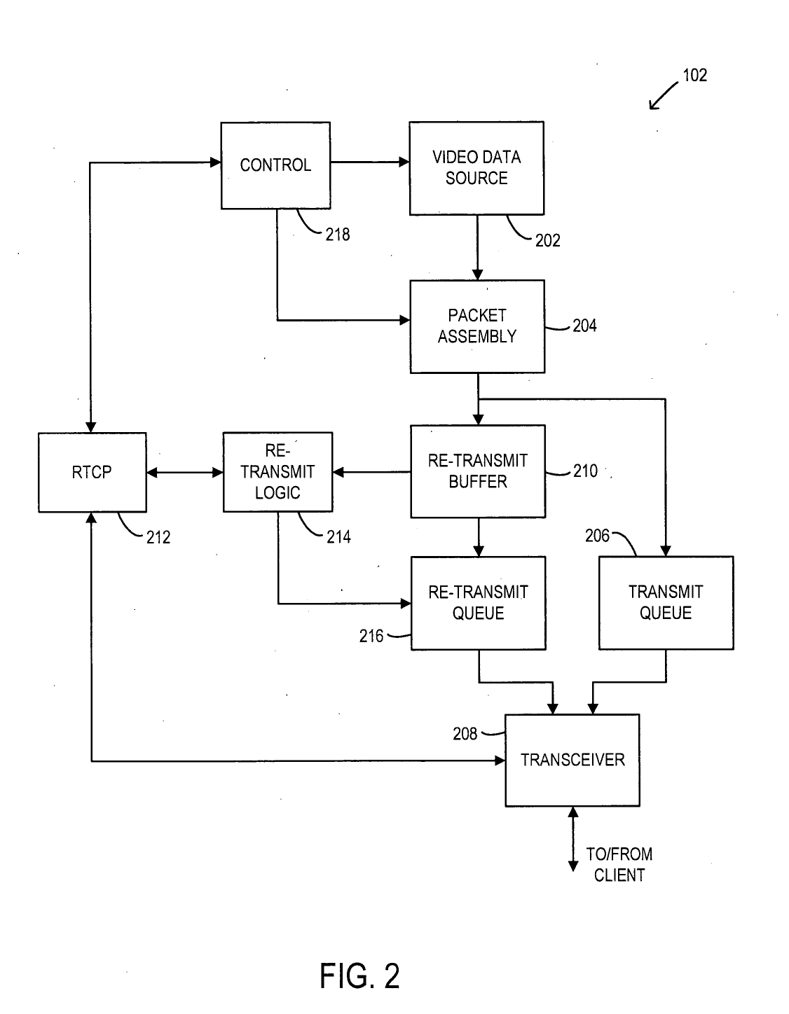

FIG. 2 is a block diagram which shows some details of the server device 102.

The server device 102 includes a source 202 of video data. The video data source 202 may be, for example, a video signal receiver/digitizer or a device for reproducing a video signal from a recording medium such as a DVD. In addition or alternatively, the video data source 202 may be connected to another device which receives, generates or reproduces a video signal. The server device 102 may also include an audio signal source/channel, which is not shown, and/or audio data may be included with the video data provided by the video data source 202.

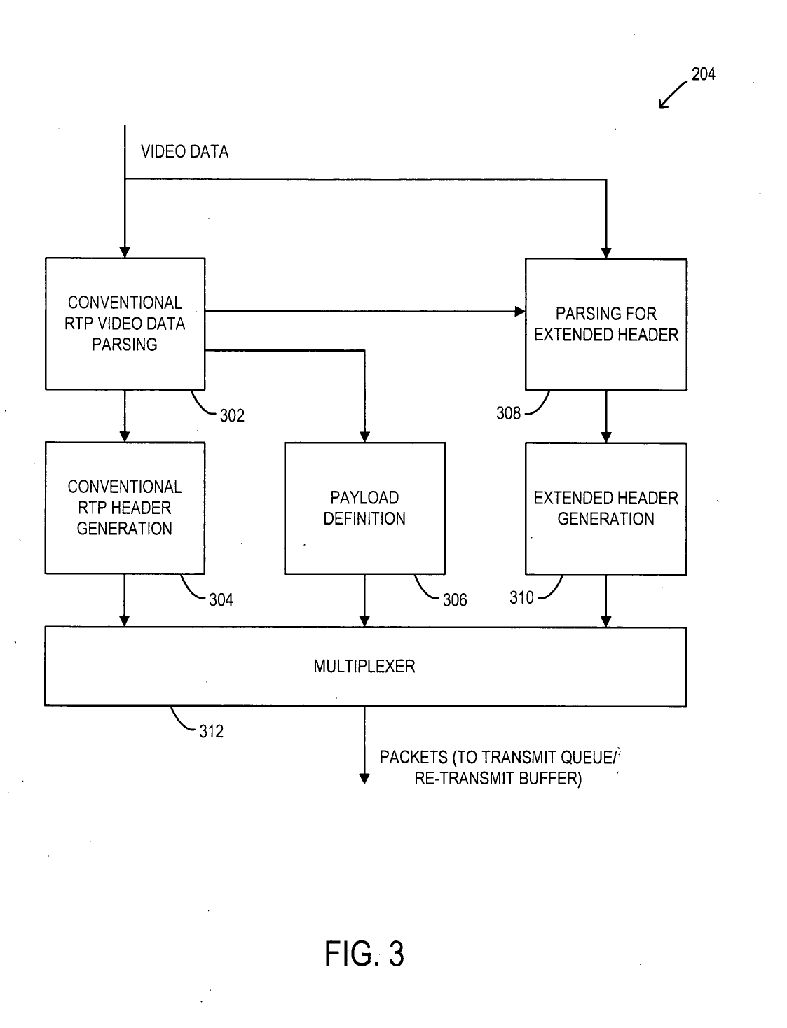

The server device 102 also includes a packet assembly block 204 which is coupled to the video data source 202 to receive the video data and to load the video data into packets. The packet assembly block 204 is operative to load video and/or audio data into packets and to append headers to the packets. Some details of the packet assembly block 204 are shown in FIG. 3. As seen from FIG. 3, the packet assembly block 204 includes a block 302 which may parse the incoming video data stream in a conventional manner required to form RTP packets from the video data. An RTP header generation block 304 may operate in a conventional manner to generate headers for the packets in accordance with the RTP protocol. In addition, a block 306 selects video (and possibly also audio) data bytes from the input data stream for incorporation in the payload of each packet.

In accordance with some embodiments, the packet assembly block 204 also includes a parsing block 308 which operates (as further described below) to parse the incoming data stream in a manner required to generate a header extension described below. As will be seen, the header extension facilitates selective re-transmission of lost packets in the system 100. A header extension generator block 310 is coupled to and responsive to the parsing block 308 to generate the header extension to support the selective re-transmission function.

The packet assembly block 204 further includes a multiplexer 312 which is coupled to the conventional header generation block 304, the payload definition block 306 and the header extension generation block 310. The multiplexer 312 is controlled (e.g., by timing/control circuitry which is not shown) to assemble data packets from the header generated by the block 304, the header extension generated by the block 310 and the payload data packets selected by block 306. The resulting packets are output from the packet assembly block 204.

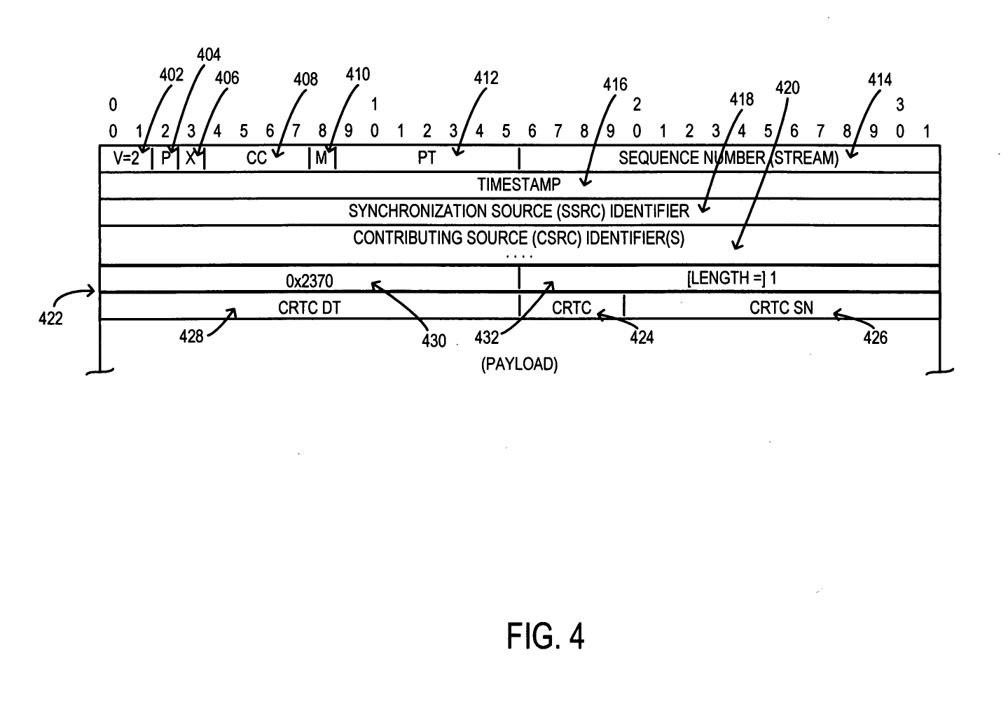

FIG. 4 is a schematic illustration of an example header format for the packets assembled by packet assembly block 204.

The header format includes a field 402 (2 bits) which identifies the version of RTP in accordance with which the server device 102 operates. The header format also includes a field 404 (1 bit) which indicates whether padding is present in the payload portion of the packet. In addition the header format includes a field 406 (1 bit) to indicate whether a header extension is present. (In this case a header extension is present.) Further, the header format includes a field 408 (4 bits) to indicate how many CSRC (contributing source) identifiers are included in the header. Still further, the header format includes a field 410 (1 bit) to indicate a marker for an event such as a frame boundary in the data stream. In addition, the header format includes a field 412 (7 bits) which identifies the type of payload included in the packet. The data in this field may indicate the format for the payload and may guide the receiving device in interpreting the data in the payload.

Also, the header format includes a stream sequence number 414 (16 bits) that indicates the position of the packet in the stream of packets transmitted by the server device 102.

Further, the header format includes a timestamp 416 (32 bits) which indicates the time at which the leading data in the payload was sampled. The header format also includes a SSRC (synchronization source) identifier 418 (32 bits) to identify the synchronization source for the packet. The header format may further incorporate up to 15 CSRC (contributing source) identifiers 420 (32 bits each) to identify contributing sources of data to the packet. In some cases, no CSRC identifier may be present. The number of CSRC identifiers present is indicated in the field 408 referred to above.

All of the aspects of the header format shown in FIG. 4 and enumerated above may be provided in accordance with the RTP protocol. In addition, the header format, in accordance with some embodiments, includes a header extension indicated at 422 to support selective re-transmission of lost packets.

The header extension 422 includes a “criticality” field 424 (4 bits) which contains a data value to indicate the importance of the packet relative to other packets in the data stream. In the example shown, up to 16 different levels of importance may be assigned. For example, if the selective re-transmission function is to be applied to video data compressed in accordance with the MPEG-2 standard, packets which include data from an I-frame (intra-field encoded frame) may be given a relatively high importance level such as 14 (on a scale of 0 to 15), since each I-frame is used as a reference frame for reconstructing all of the frames in a group of pictures (GOP) which starts with the I-frame. Packets which carry data from the first P-frame (forward-predictive encoded frame) in the group of pictures may be given a slightly lower level of importance, such as 13. The packets for the second P-frame of the group of pictures may be given 12 as a level of importance and the packets for the third P-frame of the group of pictures may be given 11 as a level of importance. Packets for the last P-frame of the group of pictures (assuming 15 pictures in the group of pictures) may be given 10 as a level of importance. Each B-frame (bi-directional-predictive encoded frame) may be given 1 as a level of importance, since error concealment may be successfully performed with respect to data lost from B-frames.

Packets which carry audio data may be given a high level of importance since it may be difficult to compensate for lost audio data.

The header extension 422 also includes an importance level sequence number 426 (12 bits) to indicate the position of the packet in a sequence of packets which consists exclusively of packets having the same importance level as the current packet. (It will be appreciated that this sequence of packets may be included in the overall stream of packets along with other sequences of packets each corresponding to a respective level of importance and composed exclusively of packets having the respective level of importance. In generating each sequence of importance level sequence numbers, the header extension generator block 310 (FIG. 3) counts only the packets having the respective level of importance for the sequence in question. It will also be appreciated that the importance level sequence number 426 is almost always different from the stream number sequence 414.) To assign importance level sequence numbers, the header extension generator block 310 may maintain a respective counter (not separately shown) for each level of importance and may increment the counter each time a packet of the corresponding level of importance is assembled.

The header extension 422 also includes a “delta time” field 428 (16 bits). The value in this field represents the difference in timestamps between the current packet and the most immediate preceding packet which had the same importance level as the current packet.

In addition, the header extension 422 includes an identifier 430 (16 bits) to identify the type of the header extension. In this case the identifier indicates that the header extension is of a type to support selective re-transmission of lost packets. Also included in the header extension 422 is a length field 432 (16 bits) to indicate how many more 32-bit blocks are in the header extension (in this case there is one more 32-bit block).

The header extension 422 for each packet may be generated by the header extension generator block 310. The balance of the header may be generated by the RTP header generator block 304.

Referring again to FIG. 2, the server device 102 includes transmit queue storage block 206 which is coupled to the packet assembly block 204 to receive the packets assembled by the packet assembly block 204. The packets are queued up for transmission in the transmit queue storage block 206.

The server device 102 further includes a transceiver 208 which is coupled to the transmit queue storage block 206. The transceiver 208 operates to wirelessly transmit to the client device 104 (FIG. 1) the packets queued up in the transmit queue storage block 206. The transmission may be performed, for example, generally in accordance with the IEEE 802.11 and RTP standards. As will be seen, the transceiver 208 may also operate to receive feedback messages transmitted from the client device 104 to the server device 102.

Still further, the server device 102 includes a re-transmit buffer 210 which is coupled to the packet assembly block 204 to temporarily store copies of the packets assembled by the packet assembly block 204.

In addition, the server device 102 includes an RTCP message generating and handling block 212 which is coupled to the transceiver 208 to handle feedback messages received by the transceiver 208 from the client device 104 in accordance with the RTCP (real time control protocol) protocol. The RTCP block 212 may also generate RTCP messages to be sent to the client device 104 via the transceiver 208.

Still further, the server device 102 includes re-transmit logic 214 which is coupled to the RTCP block 212 and to the re-transmit buffer 210. The re-transmit logic 214 responds to re-transmit request messages received at the server device 102 via the transceiver 208 and the RTCP block 212 by examining the re-transmit buffer 210 to determine whether a lost packet, for which the message requests re-transmission, is present in the re-transmit buffer. If the requested packet is in the re-transmit buffer 210, the re-transmit logic 214 causes the requested packet to be queued up for transmission in the re-transmit queue storage block 216, which is also part of the server device 102. The re-transmit queue storage block 216 is coupled to the transceiver 208. The transceiver 208 may give preference to packets queued up for re-transmission in the re-transmit queue storage block 216, and thus may transmit packets in the re-transmit queue storage block 216 prior to packets in the transmit queue storage block 206.

The server device 102 also may include a control block 218, which may be coupled to other blocks such as the video data source 202, the packet assembly block 204 and the RTCP block 212. The control block 218 may control the over-all operation of the server device 102 and may, for example, be constituted by a suitably programmed general purpose processing device (e.g., a microprocessor), which is not separately shown. Software and/or firmware to control the processor may be stored in one or more memory devices which also are not separately shown but which may be coupled to the processor. Moreover, part or all of the other functional blocks shown in FIG. 2 may be constituted by the same processor or one or more additional programmable processors. Although not so indicated in the drawing, there may also be a connection for the purpose of control and/or communication between the control block 218 and the transceiver 208.

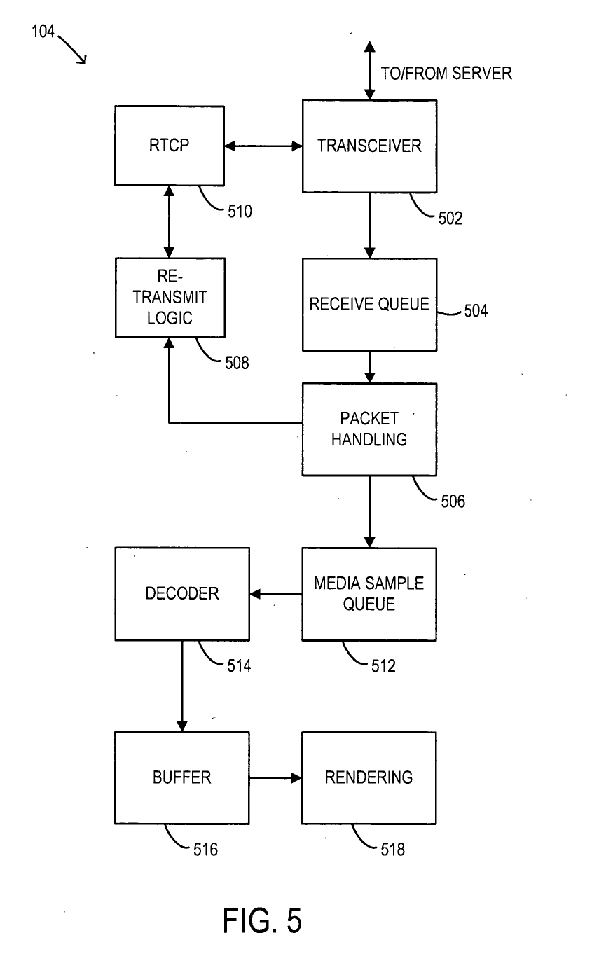

FIG. 5 is a block diagram which shows some details of the client device 104.

The client device 104 includes a transceiver 502 which is operable to receive data packets wirelessly transmitted by the server device 102. For example, the transceiver 502 may operate in accordance with the IEEE 802.11 standard. As will be seen, the transceiver 502 may also operate to transmit feedback messages to the server device 102.

The client device 104 also includes a receive queue storage block 504 which is coupled to the transceiver 502 to store the incoming data packets.

In addition, the client device 104 includes a packet handling block 506 which is coupled to the receive queue storage block 504. The packet handling block 506 operates to perform intake processing on the received data packets. In addition, in accordance with some embodiments, the packet handling block 506 detects when packets have been lost in the wireless communication channel and cooperates with re-transmit logic 508 to selectively request re-transmission of lost packets. The re-transmit logic 508 is part of the client device 104 and is coupled between the packet handling block 506 and an RTCP block 510. The RTCP block 510 is also part of the client device 104 and operates to generate feedback messages in accordance with the RTCP protocol. For example, such messages may include re-transmission requests for lost packets. The re-transmission requests may be initiated by the re-transmit logic 508.

The RTCP block 510 is also coupled to the transceiver 502, which wirelessly transmits feedback messages generated in the RTCP block 510. In addition, the transceiver 502 may receive RTCP control messages which are transmitted by the server device 102 and which are handled by the RTCP block 510.

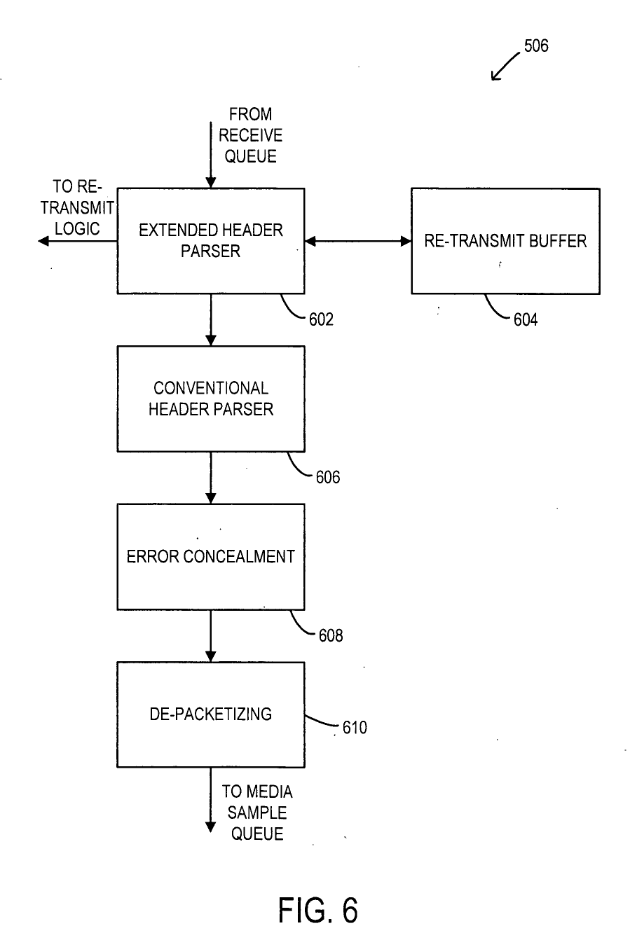

FIG. 6 is a block diagram which shows some details of the packet handling block 506.

As seen from FIG. 6, the packet handling block 506 includes a header extension parsing block 602. The header extension parsing block reads the header extensions 422 (FIG. 4) of the packets stored in the receive queue storage block 504 (FIG. 5). Based on the header extension data, the extended header parsing block 602 may detect that a packet has been lost in transmission, and the extended header parsing block 602 may then trigger the re-transmit logic 508 (FIG. 5) to determine whether to request re-transmission of the lost packet.

The header extension parsing block 602 may also operate to detect when re-transmitted packets are received and to temporarily store the re-transmitted packets in a re-transmit buffer 604 that is part of the packet handling block 506 and is coupled to the heading extension parsing block 602.

The packet handling block 506 also includes a header parsing block 606 which is coupled to the header extension parsing block 602. The header extension parsing block 602 may operate to sequentially pass to the header parsing block 606, as appropriate, either a re-transmitted packet stored in the re-transmit buffer 604 or a packet queued in the receive queue storage block 504. The header parsing block 606 may operate in a conventional manner to read the conventional RTP header elements of the packets received from the header extension parsing block 602.

The packet handling block 506 further includes an error concealment block 608. In a case where a packet is lost in transmission and is not re-transmitted (or if re-transmitted, is not received in time), the error concealment block may operate to replace missing image data with correspondingly-positioned image data from a previous image in the video data stream.

In addition, the packet handling block 506 includes a de-packetizing block 610. The de-packetizing block 610 operates to extract the image and/or audio data from the packets and to form a stream of media data.

Referring once more to FIG. 5, the client device 104 further includes a media sample queue storage block 512. The media sample queue storage block 512 is coupled to the packet handling block 506 to receive from the de-packetizing block 610 (FIG. 6) the stream of media data. The media data is queued up in the media sample queue storage block 512 to await decoding by the decoder block 514 which is also part of the client device 104 and which is coupled to the media sample queue storage block 512. The decoder 514 may operate in a conventional manner to decode the compression-encoded media data stream received via the media sample queue storage block 512. For example, MPEG-2 decoding may be applied by the decoder 514, if appropriate.

The client device 104 may also include a buffer 516 coupled to the decoder 514 to temporarily store the decoded media data output from the decoder 514. Further, the client device may include (or be coupled to) a rendering device or devices 518. The rendering device or devices 518 may be coupled to the buffer 516 and may operate to present the decoded media data in human-perceivable form. For example, the rendering device or devices 518 may include a flat panel display monitor or CRT and/or the drivers for such devices. In addition or alternatively, the rendering device or devices 518 may include one or more loudspeakers and/or drivers for the same.

In some embodiments, one or more of the functional blocks shown in FIGS. 5 and 6 may be constituted by one or more general purpose processing devices (e.g., a microprocessor or microprocessors) which are not separately shown. The software and/or firmware to control the processors may be stored in one or more memory devices (not separately shown) coupled to the processor(s).

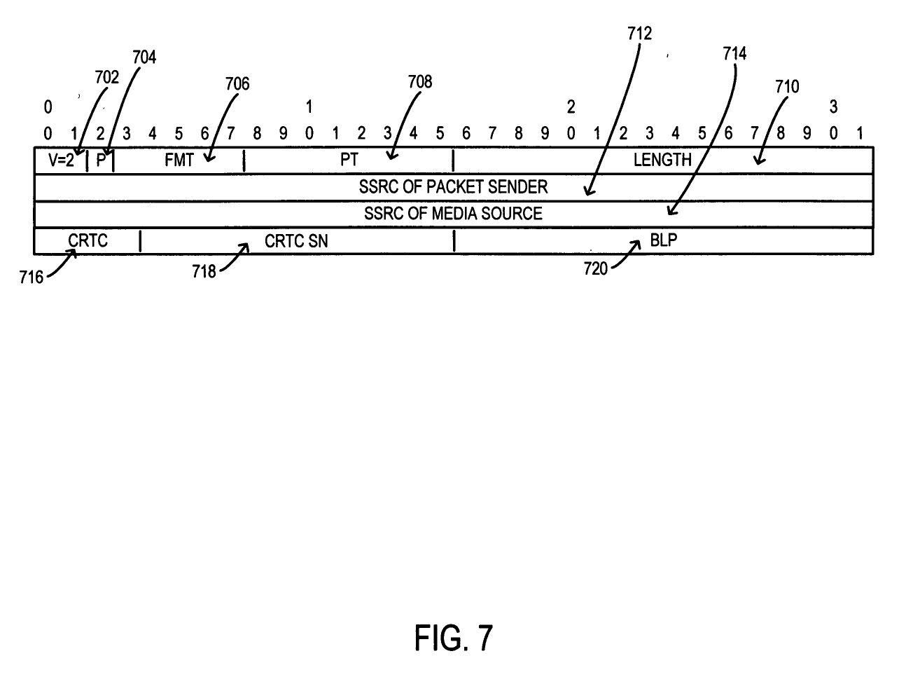

Adverting again to the RTCP block 510 shown in FIG. 5, there will now be described, with reference to FIG. 7, a format that may be employed for re-transmission request messages generated by the RTCP block in response to the re-transmit logic 508 and transmitted to the server device 102 by the client device 104 via its transceiver 502. Referring then to FIG. 7, the re-transmission request message format may include a version field 702 (2 bits) which identifies the version of RTP in accordance with which the client device 104 is operating.

The re-transmission request message format also includes a field 704 (1 bit) to indicate whether the re-transmission request message includes padding bytes.

Also included in the re-transmission request message format is a feedback message type field 706 (5 bits) which contains a code to indicate the type of the message. In this example, the code value is one which indicates that the message is a packet re-transmission request.

The re-transmission request message format also includes a payload type field 708 (8 bits) to indicate the type of payload in the message. In this example, the data in the field indicates a payload type that is suitable for a packet re-transmission request.

The re-transmission request message format further includes a length field 710 (16 bits) to indicate the length (in bytes) of the message.

Still further, the re-transmission request message format includes a SSRC (synchronization source) identifier 712 (32 bits) to identify the synchronization source for the message (in this example, the client device). The re-transmission request message format also includes a SSRC identifier 714 (32 bits) to identify the source of the lost packet that the message is requesting for re-transmission.

The re-transmission request message format further includes fields 716 and 718 to identify a lost packet for which re-transmission is requested. In particular, field 716 (4 bits) contains a data value that indicates the level of importance that was assigned to the lost packet by the server device, and field 718 (12 bits) contains the importance level sequence number that indicates the position of the lost packet in the sequence of packets having the same level of importance as the lost packet.

In addition, in some embodiments, the re-transmission request message format may include a bitmap for lost packets 720 (16 bits). The bitmap field 720 may be employed to request re-transmission of at least one additional lost packet besides the lost packet identified by fields 716 and 718. With the bitmap field 720, a single re-transmission request message may be employed to request re-transmission of more than one lost packet (e.g., to request re-transmission of up to 17 lost packets). Each “1” bit in the bitmap field 720 may represent a respective additional lost packet and the position of the “1” bit in the bitmap field 720 indicates the position of the additional lost packet relative to the lost packet identified by fields 716 and 718 in the sequence of packets having the same level of importance as the lost packet identified by fields 716 and 718. In particular, if the least significant bit in the bitmap field 720 is designated bit 1 and the most significant bit in the bitmap field 720 is designated bit 16, then a “1” bit in bit position i in the bitmap field 720 indicates a request for re-transmission of the packet having the importance level indicated in field 716 and an importance level sequence number equal to CRTCSN+i, where CRTCSN is the importance level sequence number indicated in field 718.

In the event of a loss of a block of packets in excess of 17 consecutive packets of the same level of importance, more than one re-transmission request may be transmitted to request re-transmission of all of the packets of the lost block of packets.

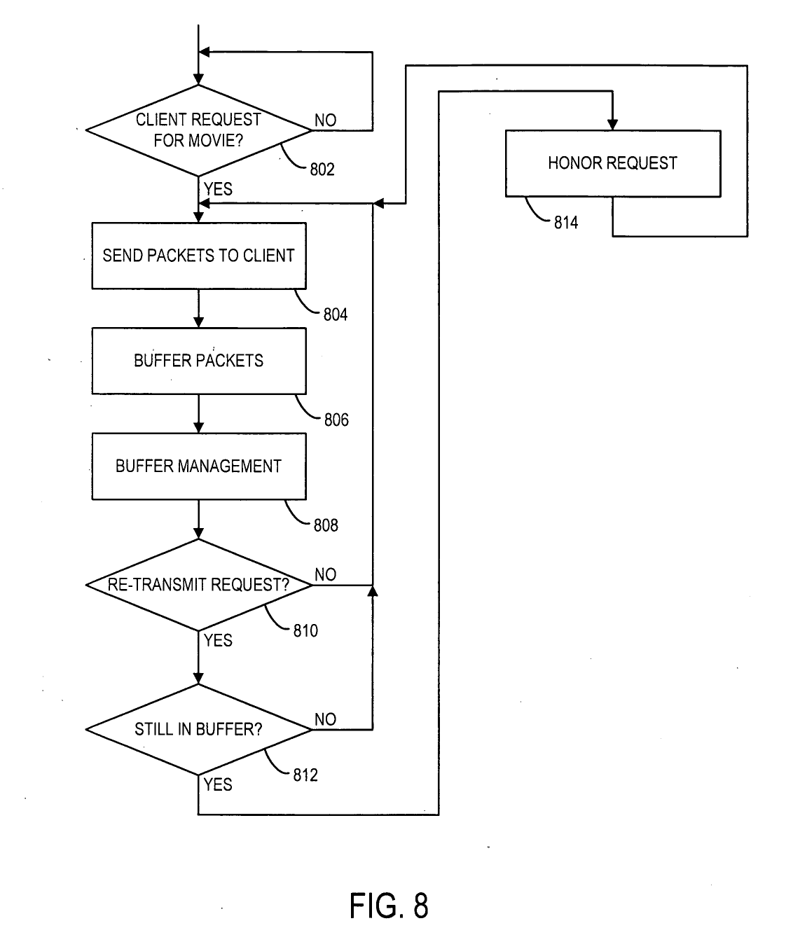

FIG. 8 is a flow chart that illustrates a process performed by the server device 102 (e.g., by one or more of the following components: control block 218, RTCP block 212, re-transmit logic 214, re-transmit buffer 210 and transceiver 208, operating alone or in cooperation with each other).

At 802 in FIG. 2, it is determined whether a request has been received from the client device 104 to indicate that the client device 104 is requesting downloading of a particular content program, such as a particular movie. If such a request is received, the server device proceeds (as indicated at 804) to transmit to the client device a sequence of packets which contain the media data that comprise the requested content program. In addition, as indicated at 806, the server device 102 temporarily stores in the re-transmit buffer 210 the most recently transmitted packets to hold the same for possible re-transmission if requested by the client device 104. In some embodiments, the capacity of the re-transmit buffer 210 may be sufficient to store two to three frames of video data. At 808, the re-transmit buffer 210 is managed, for example, by writing new packets over the oldest packets in the re-transmit buffer. In some embodiments, however, the length of time that a packet is maintained in the re-transmit buffer may vary with the importance level assigned to the packet, such that packets having a higher level of importance are buffered for a longer period of time than packets having a lower level of importance.

As indicated at 810, the server device 102 determines whether it has received from the client device 104 a request for re-transmission of a packet (or more than one packet). If a re-transmission request message is received, it is next determined, at 812, whether the requested packet(s) is (are) still in the re-transmit buffer 210. If such is the case, then (as indicated at 814) the requested packet or packets are loaded into the re-transmit queue 216 from the re-transmit buffer 210 by the re-transmit logic 214, and the requested packet or packets are then transmitted from the re-transmit queue 216 to the client device 104 by the transceiver 208.

In some embodiments, the server device 102 does not always re-transmit a requested packet even when the requested packet remains in the re-transmit buffer 210. For example, when there is a scarcity of bandwidth for re-transmitting packets, the server device may determine whether or not to re-transmit a requested packet based at least in part on the level of importance that was assigned to the requested packet. In such situations, requested packets having higher importance levels may be re-transmitted while requested packets having lower importance levels may not be transmitted.

In some embodiments, the server device may only buffer, for possible re-transmission if requested, packets having at least a minimum level of importance. In some embodiments, the minimum level of importance for this purpose may be adjusted by the server device to reflect current conditions, such as available bandwidth and/or current error rate.

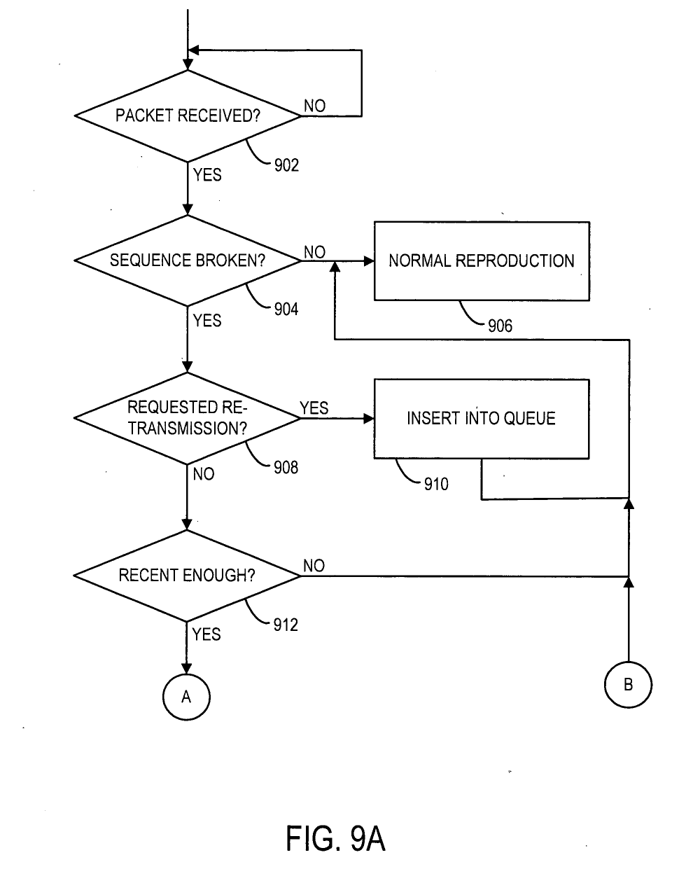

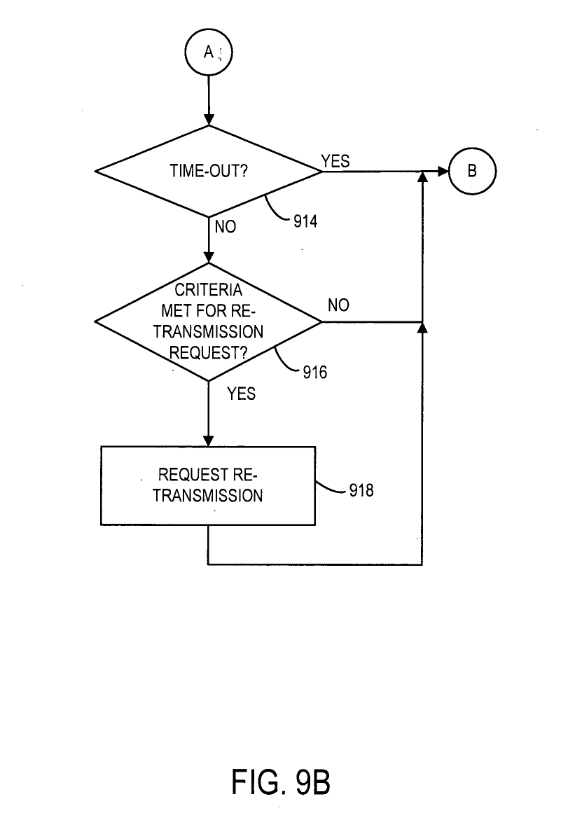

FIGS. 9A and 9B together form a flow chart that illustrates a process performed by the client device 104.

At 902 in FIG. 9A, it is determined whether a packet is received via the transceiver 502 (FIG. 5). If so, then as indicated at 904, the header extension parsing block 602 (FIG. 6) reads the importance level field 424 (FIG. 4) and the importance level sequence number 406 in the header extension 422 for the packet and compares the importance level sequence number with the importance level sequence number of the most recently received previous packet having the same level of importance to determine whether there is a break in the importance level sequence numbers for packets of that level of importance. If there is no break in the importance level sequence numbers, then reproduction (rendering) of the received packet may proceed in normal course, as indicated at 906.

However, if it is determined at 904 that the importance level sequence number sequence has been broken, it is next determined, at 906, whether the packet which was just received is one that was previously lost and requested for re-transmission. If such is the case, then the packet is inserted at its proper place in the queue of packets awaiting further processing, as indicated at 910. (In some embodiments, the re-transmitted packet is inserted in the queue only if the time for processing and rendering the packet has not expired.)

If it is determined at 908 that the packet is not one that had previously been lost and re-transmitted, it is next determined at 912 whether too much time has elapsed since the lost packet was transmitted. That is, the re-transmit logic 508 (FIG. 5) may consider the “delta time” value in field 428 of the packet header extension 422 to determine how long it has been since the lost packet was transmitted. If the time of transmission was so long ago that it would not be worthwhile to request re-transmission of the lost packet, then reproduction of the media data proceeds without the client device requesting re-transmission of the lost packet. Similarly, at 914 in FIG. 9B, it is considered whether a time-out period has elapsed in terms of waiting for out-of-order delivery of packets. If not, then normal processing continues.

However, if no timing consideration bears against requesting re-transmission, it is next determined at 916 whether other criteria have been satisfied so that a re-transmission request should be sent. For example, the re-transmit logic 508 may compare the level of importance of the lost packet (as indicated by the most recent packet showing a break in importance level sequence numbers) with a minimum level of importance required to justify requesting re-transmission. In some embodiments, that minimum level of importance may be determined on the basis of the bandwidth available for transmission of data from the server device to the client device, and may be changed from time to time as the available bandwidth changes. In addition or alternatively, the minimum level of importance required to justify re-transmission may be determined based on the current error rate, and again may be changed as the error rate changes.

Assuming that the level of importance of the lost packet is high enough to justify re-transmission, then a re-transmission request message like that illustrated in FIG. 7 is sent to the server device 102 (as indicated at 918 in FIG. 9B) by cooperation of the re-transmit logic 508, the RTCP block 410 and the transceiver 502.

By allowing for selective requests for re-transmission of lost packets, embodiments described herein may promote efficient use of bandwidth used for lost packet re-transmission.

Embodiments have been described herein in the context of a system that utilizes RTP, but alternatively, importance level assignments, sequence numbering within importance levels, and other features described herein may be employed with protocols other than RTP.

As used herein and in the appended claims, “appending” a header to a packet includes placing the header at the beginning of the packet.

The flow charts and other descriptions of processes herein are not intended to imply a fixed order of performing the process stages. Rather, the process stages may be performed in any order that is practicable.

It will be appreciated that each transceiver referred to herein may include both a transmitter to transmit data packets and/or messages and a receiver to receive data packets and/or messages.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. A method comprising:
loading video data into packets; and
appending headers to said packets;
wherein each of said headers includes a first field and a second field;
said first field including a data value to indicate an importance of a respective packet relative to other packets; and
said second field including an importance level sequence number to indicate a position of said respective packet in a sequence of packets which have the same importance level as said respective packet.

2. The method of claim 1, further comprising:
detecting a loss of one of said packets by detecting a break in said sequence numbers among received packets.

3. The method of claim 2, further comprising:
detecting a timing of said lost packet; and
determining whether to request re-transmission of said lost packet based at least in part on the detected timing.

4. The method of claim 2, further comprising:
requesting re-transmission of a lost packet by sending a message that identifies said lost packet by said data value in said first field and by said importance level sequence number of said lost packet.

5. The method of claim 4, further comprising:
requesting re-transmission of at least one additional lost packet by indicating said at least one additional lost packet by using a bit map field in said message.

6. The method of claim 2, further comprising:
determining whether to request re-transmission of a lost packet, said determining based at least in part on (i) the importance of said lost packet; and (ii) an amount of bandwidth available for transmission of said packets.

7. The method of claim 1, wherein each of said headers includes a third field, said third field including a data value to indicate a difference in timing between said respective packet and a packet which immediately precedes said respective packet in said sequence of packets.

8. The method of claim 1, further comprising:
generating a plurality of sequences of importance level sequence numbers, each of said sequences of importance level sequence numbers corresponding to a respective level of importance assigned to ones of said packets.

9. The method of claim 1, wherein each of said headers includes a stream sequence number to indicate a position of said respective packet in a stream of said packets, said stream including packets collectively having more than one level of importance, said stream sequence number different from said importance level sequence number.

10. An apparatus comprising:
a source of video data; and
a packet assembly block to load the video data into packets and to append headers to said packets;
wherein each of said headers includes a first field and a second field;
said first field including a data value to indicate an importance of a respective packet relative to other packets; and
said second field including an importance level sequence number to indicate a position of said respective packet in a sequence of packets which have the same importance level as said respective packet.

11. The apparatus of claim 10, wherein each of said headers includes a third field, said third field including a data value to indicate a difference in timing between said respective packet and a packet which immediately precedes said respective packet in said sequence of packets.

12. The apparatus of claim 10, wherein said packet assembly block is operative to generate a plurality of sequences of sequence numbers, each of said sequences of sequence numbers corresponding to a respective level of importance assigned to ones of said packets.

13. The apparatus of claim 12, wherein each of said headers includes a stream sequence number to indicate a position of said respective packet in a stream of said packets, said stream including packets collectively having more than one level of importance, said stream sequence number different from said importance level sequence number.

14. An apparatus comprising:
a receiver to receive a stream of packets, at least some of said packets including video data, each of said packets including a header, each of said headers including a first field and a second field, said first field including a data value to indicate an importance of a respective packet relative to other packets, said second field including an importance level sequence number to indicate a position of said respective packet in a sequence of packets which have the same importance level as said respective packet; and
a parsing block to examine said headers and to detect a loss of one of said packets by detecting a break in said sequence numbers among received packets.

15. The apparatus of claim 14, further comprising:
re-transmit logic coupled to said parsing block; and
a transmitter coupled to said re-transmit logic;
said re-transmit logic operative to request re-transmission of a lost packet by causing said transmitter to send a message that identifies said lost packet by said data value in said first field and by said importance level sequence number of said lost packet.

16. The apparatus of claim 15, wherein said message indicates at least one additional lost packet by using a bit map field in said message.

17. The apparatus of claim 14, wherein said re-transmit logic is operative to determine whether to request re-transmission of a lost packet, said determining based at least in part on (i) the importance of said lost packet; and (ii) an amount of bandwidth available for transmission of said packets.

18. The apparatus of claim 14, wherein said parsing block is operative to detect a timing of said lost packet and said re-transmit logic is operative to determine whether to request re-transmission of said lost packet based at least in part on the detected timing.

19. A system comprising:
a server device to transmit a stream of packets; and
a client device to receive the stream of packets;
wherein said server device includes:
a source of video data; and
a packet assembly block to load the video data into packets and to append headers to said packets;
wherein each of said headers includes a first field and a second field;
said first field including a data value to indicate an importance of a respective packet relative to other packets; and
said second field including an importance level sequence number to indicate a position of said respective packet in a sequence of packets which have the same importance level as said respective packet;
wherein said client device includes:
a receiver to receive the stream of packets; and
a parsing block to examine said headers and to detect a loss of one of said packets by detecting a break in said sequence numbers among received packets.

20. The system of claim 19, wherein said client device further includes:
re-transmit logic coupled to said parsing block; and
a transmitter coupled to said re-transmit logic;
said re-transmit logic operative to request re-transmission of a lost packet by causing said transmitter to send a message that identifies said lost packet by said data value in said first field and by said importance level sequence number of said lost packet.

21. The system of claim 20, wherein said message indicates at least one additional lost packet by using a bit map field in said message.

22. The system of claim 19, wherein each of said headers includes a stream sequence number to indicate a position of said respective packet in said stream of said packets, said stream including packets collectively having more than one level of importance, said stream sequence number different from said importance level sequence number.
